(19) United States
(12) Patent Application Publication
(10) Pub. No.: US 2017/0099989 A1
(43) Pub. Date: Apr. 13, 2017

(54) OVEN

(71) Applicant: Peiying Feng, Zhongshan (CN)

(72) Inventor: Peiying Feng, Zhongshan (CN)

(21) Appl. No.: 14/876,816

(22) Filed: Oct. 7, 2015

(51) Int. Cl. A47J 37/07; A47J 37/06; A21B 1/33

(52) U.S. Cl. CPC A47J 37/0754; A21B 1/33; A47J 37/0664

(57) ABSTRACT

The present application discloses an oven comprising an oven body, wherein the oven body includes a housing, a combustion chamber, a grid plate, and a blower; the combustion chamber is arranged inside the housing and configured to accommodate barbecue charcoal, the grid plate is arranged above the housing and configured to place food, and the blower is communicated with the combustion chamber via an air channel, speeds of air flows in the combustion chamber are controlled by the blower, so that the present application can still be normally used in indoor environments or calm environments. Moreover, the blower is further provided with a speed control circuit and a speed control knob, which can adjust air flow precisely, so that thermal power can be well controlled and various barbecue effects can be achieved.

### FIELD OF THE INVENTION

The present application relates to ovens.

### BACKGROUND OF THE INVENTION

A conventional oven usually adopts a structure comprising an oven body and a support frame, wherein at least one air guide hole is defined at a lower part of the oven body, charcoal is directly placed into the oven body, a grid plate is arranged above the oven body, and thermal power and combustion efficiency of the oven is controlled via the air guide hole. However, this type of conventional oven depends on natural air flows excessively, in space where air is still or air flows are obstructed, the air guide efficiency may be very low, thereby resulting in too low combustion efficiency.

### SUMMARY OF THE INVENTION

In order to overcome the drawbacks of the prior art, the present application provided an oven.

In order to solve the above-mentioned technical problems, the present application adopts the following technical solution:

An oven comprising an oven body, wherein the oven body includes a housing, a combustion chamber, a grid plate, and a blower, the combustion chamber is arranged inside the housing, the grid plate is arranged above the housing, and the blower is communicated with the combustion chamber via an air channel.

The combustion chamber is substantially a cylindrical structure and includes a cylinder body, an upper cover arranged at an upper end of the cylinder body, a lower cover arranged at a lower end of the cylinder body, and a spacing piece arranged inside the cylinder body; an air distribution chamber is formed between the spacing piece and the lower cover, the spacing piece defines a plurality of air distribution holes, the lower cover defines an air channel hole configured to allow the air channel to communicate with the combustion chamber, and the upper cover defines a plurality of heat conduction holes.

The cylinder body defines a plurality of heat radiation holes.

The upper cover is provided thereon with a handle.

The housing is provided therein with a heat collection container, and the combustion chamber is arranged inside the heat collection container.

The housing defines a plurality of heat dissipation holes.

The blower includes a speed control circuit, and a side surface of the housing is provided with a speed control knob connected with the speed control circuit.

A bottom part of the housing is provided with a battery case, and the blower is powered by the battery case.

The blower can also be powered by a USB power supply unit, the USB power supply unit includes a power supply circuit board and a USB interface electrically connected with an input circuit of the power supply circuit board, and the USB interface is arranged on the housing.

A side surface of the housing is provided with at least one buckle device, and the grid plate is mounted at an upper end of the housing via the buckle device.

A periphery of the grid plate is provided with a fence.

The present application achieves the following advantageous effects: the oven comprises the oven body, wherein the oven body includes the housing, the combustion chamber, the grid plate, and the blower; the combustion chamber is arranged inside the housing and configured to accommodate barbecue charcoal, the grid plate is arranged above the housing and configured to place food, and the blower is communicated with the combustion chamber via the air channel, speeds of air flows in the combustion chamber are controlled by the blower, so that the present application can still be normally used in indoor environments or calm environments. Moreover, the blower is further provided with the speed control circuit and the speed control knob, which can adjust air flow precisely, so that thermal power can be well controlled and various barbecue effects can be achieved.

### BRIEF DESCRIPTION OF THE DRAWINGS

The present application will be further described below with reference to the accompanying drawings and embodiments.

FIG. 1 is a structural schematic view of a first embodiment of the present application;

FIG. 2 is a disassembled schematic view of the first embodiment of the present application shown in FIG. 1;

FIG. 3 is a structural schematic view of a second embodiment of the present application.

### DETAILED DESCRIPTION OF THE PREFERRED EMBODIMENT

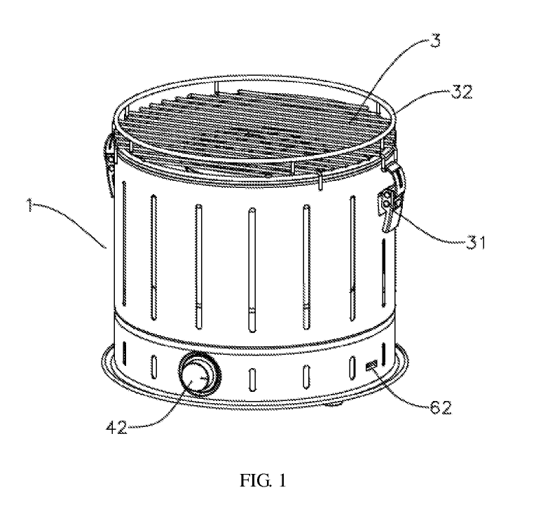

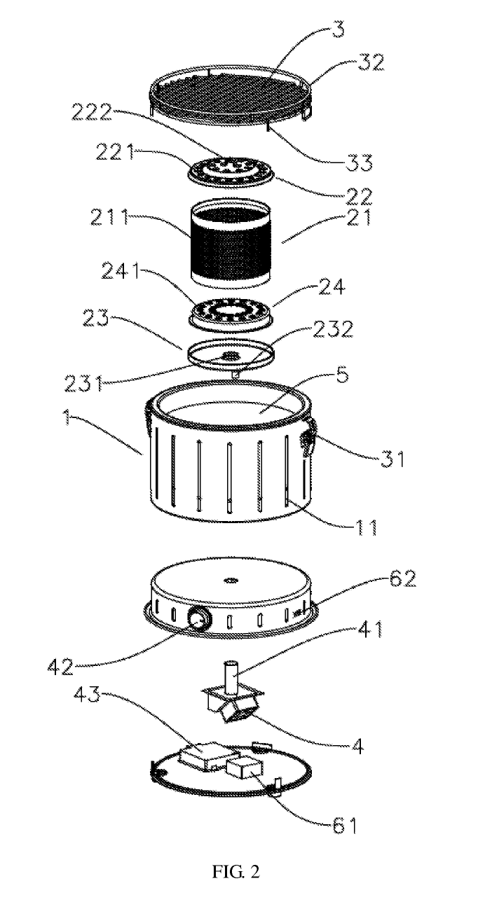

Referring to FIG. 1 and FIG. 2, which are structural schematic views of a first embodiment of the present application. As shown in FIG. 1 and FIG. 2, an oven comprises an oven body, wherein the oven body includes a housing 1, a combustion chamber, a grid plate 3, and a blower 4; the combustion chamber is arranged inside the housing 1 and configured to accommodate barbeque charcoal, the grid plate 3 is arranged above the housing 1 and configured to place food, and the blower 4 is communicated with the combustion chamber via an air channel 41, speeds of air flows in the combustion chamber can be controlled by the blower 4, so that the present application can still be normally used in indoor environments or calm environments.

As shown in FIG. 2, the combustion chamber is a cylindrical structure, which includes a cylinder body 21, an upper cover 22 arranged at an upper end of the cylinder body 21, a lower cover 23 arranged at a lower end of the cylinder body 21, and a spacing piece 24 arranged inside the cylinder body 21; an air distribution chamber is formed between the spacing piece 24 and the lower cover 23, the spacing piece 24 defines a plurality of air distribution holes 241, and the lower cover 23 defines an air channel hole 231 configured to allow the air channel 41 to communicate. In this embodiment, the air channel 41 is a tubular structure, air flows generated by the blower 4 can enter the air distribution chamber via the air channel 41, and air can be uniformly distributed into the combustion chamber via the air distribution holes 241 to increase combustion efficiency of the barbecue charcoal. Furthermore, the spacing piece 24 can further provide an action of insulating charcoal residue, which prevents the charcoal residue from obstructing the air channel 41.

As shown in FIG. 2, the upper cover 22 defines a plurality of heat conduction holes 221, and heat flow can be spread to the grid plate 3 via the heat conduction holes 221; the cylinder body 21 defines a plurality of heat radiation holes 211, which are configured to spread heat from the circumference of cylinder body 21, and provide certain flow conduction action to improve the combustion effect. Furthermore, the housing 1 is provided therein with a heat collection container, and the combustion chamber is arranged inside the heat collection container 5; the heat collection container 5 is an upward heat collection structure, such as a cone-shaped or pot-shaped structure, which can well radiate heat to the grid plate 3 above the housing 1, so that heat loss is reduced and heat efficiency is increased; moreover, the heat collection container 5 can effectively insulate heat radiation to reduce the temperature of the housing 1 and prevent empyrosis. A bottom part of the lower cover 23 is further provided with a plurality of supporting feet 232, which prevent the combustion chamber from coming into contact with the heat collection container 5 and thereby reduce a speed of heat diffusion.

Preferably, the housing 1 defines a plurality of heat dissipation holes 11, which are configured to increase heat dissipation efficiency of the housing 1, further decrease the temperature of the housing 1, and thereby prevent the occurrence of empyrosis.

As shown in FIG. 2, preferably, the upper cover 22 is provided thereon with a handle 222, which facilitates opening the upper cover 22 to place charcoal into the combustion chamber or remove charcoal residue.

Preferably, the blower 4 is further provided with a speed control circuit, and a side surface of the housing 1 is provided with a speed control knob 42 connected with the speed control circuit. Through the speed control knob 42 and the speed control circuit, air flow can be adjusted precisely, so that thermal power can be well controlled and various barbecue effects can be achieved. The speed control circuit can be selected according to the specific type of the motor of the blower, for example, the speed control circuit may be a direct current (DC) motor speed control circuit, a servo motor speed control circuit, a stepping motor speed control circuit, a frequency conversion motor speed control circuit, and so on. The above-mentioned speed control circuits can be well known technologies in the technical field of motor speed control, and therefore do not need to be detailed here.

Preferably, a bottom part of the housing 1 is provided with a battery case 43, AA batteries, AAA batteries, or other types of batteries can be mounted in the battery case 43, the blower 4 can be power by the battery 43, thereby facilitating outdoor carry and use of the present application. Furthermore, in the present application, the blower 4 can also be powered by a USB power supply unit, the USB power supply unit includes a power supply circuit board 61 and a USB interface 62 electrically connected with an input circuit of the power supply circuit board 61, and the USB interface 62 is arranged on the housing 1; the USB interface 62 can be a micro USB interface, a standard USB interface, and so on, so that the present application can be electrically connected with common mobile power supplies and directly powered by the mobile power supplies, and thus it is more convenient to use. The USB power supply unit, the power supply circuit 61, and the USB interface 62 can be made according to common technologies, which are well known by one of ordinary skill in the art, therefore, their working principles do not need to be detailed here.

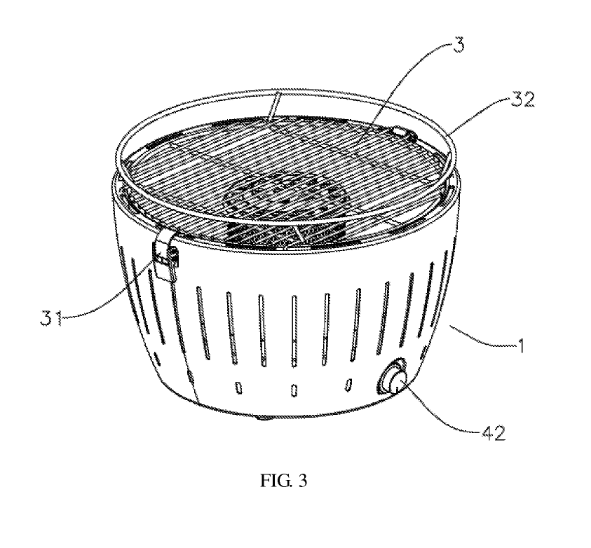

Also referring to FIG. 3, preferably, a side surface of the housing 1 is provided with at least one buckle device 31, and the grid plate 3 is mounted at an upper end of the housing 1 via the buckle device 31 so as to facilitate detaching and cleaning the grid plate 3, adding charcoal, and removing charcoal residue.

Preferably, a periphery of the grid plate 3 is provided with a fence 32, which can prevent food from accidentally slipping out, and can further prevent hands from mistakenly touching the grid plate 3. The periphery of the grid plate 3 is further provided with at least one bent rod 33 that is bent downwards and corresponds to an outer shape of the housing 1, the bent rod 33 is configured to prevent the grid plate 3 from accidentally slipping and deflecting.

In this embodiment, the housing 1 is a straight cylindrical structure. In specific implementation processes, according to various appearance design or aesthetics habits, the housing 1 can also be designed into other shapes, such as a bowl-shaped structure with an arc-shaped edge (e.g., as shown in FIG. 3), a rectangular structure, a polygonal structure, etc., and these shapes do not need to be detailed here.

Preferable embodiments of the present application are detailed hereinbefore. Of course, the present application can also adopt other forms differing from the above-described embodiments. On the premise of no deviation from the spirit of the present application, any equivalent changes or corresponding modifications made by one of ordinary skill in the art should be included in the protection scope of the present application.

1. An oven comprising an oven body, wherein the oven body includes a housing (1), a combustion chamber, a grid plate (3), and a blower (4), the combustion chamber is arranged inside the housing (1), the grid plate (3) is arranged above the housing (1), and the blower (4) is communicated with the combustion chamber via an air channel (41);
wherein the combustion chamber is substantially a cylindrical structure and includes a cylinder body (21), an upper cover (22) arranged at an upper end of the cylinder body (21), a lower cover (23) arranged at a lower end of the cylinder body (21), and a spacing piece (24) arranged inside the cylinder body (21); an air distribution chamber is formed between the spacing piece (24) and the lower cover (23), the spacing piece (24) defines a plurality of air distribution holes (241), the lower cover (23) defines an air channel hole (231) configured to allow the air channel (41) to communicate with the combustion chamber, and the upper cover (22) defines a plurality of heat conduction holes (221);
wherein, air flows generated by the blower (4) enter the air distribution chamber via the air channel (41), and are uniformly distributed into the combustion chamber via the air distribution holes (241) of the spacing piece (24).

2. (canceled)

3. The oven according to claim 2, wherein the cylinder body (21) defines a plurality of heat radiation holes (211).

4. The oven according to claim 2, wherein the upper cover (22) is provided thereon with a handle (222).

5. The oven according to claim 1, wherein the housing (1) is provided therein with a heat collection container (5), and the combustion chamber is arranged inside the heat collection container (5).

6. The oven according to claim 1, wherein the housing (1) defines a plurality of heat dissipation holes (11).

7. The oven according to claim 1, wherein the blower (4) includes a speed control circuit, and a side surface of the housing (1) is provided with a speed control knob (42) connected with the speed control circuit.

8. The oven according to claim 1, wherein a bottom part of the housing (1) is provided with a battery case (43), and the blower (4) is powered by the battery case (43).

9. The oven according to claim 1, wherein the blower (4) is powered by a USB power supply unit, the USB power supply unit includes a power supply circuit board (61) and a USB interface (62) electrically connected with an input circuit of the power supply circuit board (61), and the USB interface (62) is arranged on the housing (1).

10. The oven according to claim 1, wherein a side surface of the housing (1) is provided with at least one buckle device (31), and the grid plate (3) is mounted at an upper end of the housing (1) via the buckle device (31).
